(19) United States
(12) Patent Application Publication
(10) Pub. No.: US 2003/0144949 A1
(43) Pub. Date: Jul. 31, 2003

(54) Web-based mortgage broker application

(76) Inventor: Ed Blanch, Fairfield, CA (US)

Correspondence Address: Richard C. Litman, LITMAN LAW OFFICES, LTD., P.O. Box 15035, Arlington, VA, 22215, US

(21) Appl. No.: 10/054,894

(22) Filed: Jan. 25, 2002

(51) Int. Cl. G06F 17/60

(52) U.S. Cl. 705/38

(57) ABSTRACT

The Web-based mortgage broker application is a software program which provides a mortgage broker with a quick summary of loan fees and mortgage loan underwriting conditions before formal submission to a mortgage lender. The program executes on a server computer and is accessible by the broker from a client computer through the Internet using a browser. The program provides Web pages having drop-down lists from which the mortgage broker selects the desired loan parameters. The program computes add-on fees and determines underwriting conditions and guidelines from the parameters entered, and displays the results. The Web-based mortgage broker application permits the broker to determine whether the underwriting condition for a given loan can be met before formal submission to a lender, and accelerates lender processing by eliminating the need to re-analyze a loan submission.

### BACKGROUND OF THE INVENTION

1. Field of the Invention

The present invention relates to a Web-based mortgage broker application, and particularly to a system, computer software program, and computerized method for providing a mortgage broker with quick and accurate pricing information and underwriting conditions for a specific prospective mortgage loan, and more particularly to a software program permitting the broker to enter loan parameters by dropdown list boxes.

2. Description of the Art

The purchase of real property, whether for residential or commercial purposes, requires a substantial expenditure of funds. Normally the purchaser is unable to furnish the entire purchase price in cash, and must finance the purchase through a purchase money mortgage. The process of applying for and obtaining approval of a mortgage can be a time consuming process, and usually requires the services of a mortgage broker to place the loan. Various efforts have been made to streamline the process of obtaining mortgage financing.

U.S. Pat. No. 5,644,726, issued to Oppenheimer, describes a process and method for financing the purchase of real property by mortgagors in which capital for purchase of the home is supplied by two lenders protected under a single mortgage instrument, the mortgage debt being split between a first mortgagee accepting fixed payments of principal and interest over the early years of the mortgage, and a Joint Venture Partner furnishing the rest of the purchase money and receiving immediate ownership of an equity interest in the property, the debt to the Joint Venture Partner not being payable until the fixed mortgage portion is retired. A computer calculates multiple mortgagor financial obligations and mortgagee rights and prints instruments embodying those obligations and rights. The system also employs generally available house price indices as proxies for equity values, produces periodic reports to mortgagors of obligated balances and determines mortgagee and mortgager balances upon sale and/or termination of instruments produced by the system.

U.S. Pat. No. 5,963,952, issued to Smith, describes an Internet based data entry system. Problems with existing Web browser technologies include an inability to support local storage of entered data due to security issues. A file save option saves the source contents of the currently displayed Web page without any entered data. The invention provides for a method and system for capture of data entered onto a Web page displayed in a Web browser, including local storage of the entered data on a hard disk of the client computer. The invention receives entered data in a primary document and generates a secondary document having the entered data as initial conditions within the secondary document for storage to a hard disk.

U.S. Pat. No. 5,991,745 issued to Kiritz, describes a system and method of calculating monetary payments by a lender to a borrower in a reverse mortgage loan transaction based on the value of an asset using at least one of a plurality of constants stored in look-up tables. The process includes inputting borrower information such as the borrower's birthdate or age. Property specific information is also input, such as appraised property value. Equity share information is also input. With the equity share information and borrower's age, the process looks-up a tenure conversion factor from a look-up table. The loan type is input as one of tenure, line of credit or modified tenure and appropriate variables.

U.S. Pat. No. 6,012,047, issued to Mazonas et al., describes a data processing system for selectively determining an appropriate balance of credit parameters associated with the issuance of reverse equity mortgage financing. The system manages the risk associated with the credit by structuring a concurrent single premium deferred annuity to provide future cash flows starting at a system determined date corresponding to actuarially determined requirements of the borrower. The data processing system accepts inputs of the critical data required to perform the calculations and provides a detailed assessment of the proper level of credit and blend of annuity payments for the borrower, thereby solving the principal problem associated with reverse mortgage products.

U.S. Pat. No. 6,016,482, issued to Molinari et al., describes a computer system provided for implementing, managing and tracking financial transactions. Various users may use this system to access a database for information retrieval or for entering a set of commands to cause the database to process loan transactions or fund transfers. The system is set-up so that these transaction requests may then be conveniently approved or disapproved by the lending institution. There is also a security measure in place to ensure that only proper authorized users may access this respective system to retrieve, confirm, request, alter or approve the fund transfer.

U.S. Pat. No. 6,112,190, issued to Fletcher et al., describes a method and system for assimilating data, applying reasoning mechanisms and emulating the thought processes of a credit officer for commercial credit analysis. The system aids a credit officer in the risk assessment and completion of a loan package. The system thereby improves loan turnaround time and customer service, improving loan servicing capacity, quality and consistency of credit decisions and reducing costs.

U.S. Pat. No. 6,269,347 issued to Berger, describes the use of a method for calculating a mortgage which provides application of mortgage payments to principal first, and then to interest in the amortization schedule of repayment of a conventional loan. The disclosure provides a method for calculating mortgage payments on a conventional mortgage loan by applying such payments first to reduction of principal while accumulating accrued interest.

Although the systems and methods outlined in these patents are useful, improvements involving the preparation of mortgage banking transactions can still be made. What is needed is a system that will help a mortgage broker receive price and underwriting conditions quickly and conveniently given various mortgage loan parameters. A system is needed to allow mortgage lenders to provide immediate pricing and underwriting conditions to mortgage brokers. Such a system would improve the approval and rate analysis process and reduce the time involved in pricing a loan, and in determining and receiving underwriting conditions.

None of the above inventions and patents, taken either singularly or in combination, is seen to describe the instant invention as claimed. Thus a system for providing pricing and underwriting guidelines for a mortgage loan and solving the aforementioned problems is desired.

### SUMMARY OF THE INVENTION

The Web-based mortgage broker application is a software program which provides a mortgage broker with a quick summary of loan fees and mortgage loan underwriting conditions before it is formally submitted to a mortgage lender. The program executes on a server computer and is accessible by the broker from a client computer through the Internet using a browser. The program provides Web pages having drop-down lists from which the mortgage broker selects the desired loan parameters. The program computes add-on fees and determines underwriting conditions and guidelines from the parameters entered, and displays the results. The Web-based mortgage broker application permits the broker to determine whether the underwriting condition for a given loan can be met before formal submission to a lender, and accelerates lender processing by eliminating the need to re-analyze a loan submission.

Accordingly, it is a principal object of the invention to quickly provide a mortgage broker with accurate pricing information and underwriting conditions for a prospective mortgage loan.

It is another object of the invention to provide a mortgage broker with the exact conditions required to have a particular prospective mortgage loan formally approved.

It is a further object of the invention to provide a mortgage broker with add-on fee costs for a specific mortgage loan.

It is another object of the invention to utilize pull-down list boxes to enter mortgage loan information instead of data entry procedures.

Still another object of the invention is to reduce the amount of time needed for approval and pricing analysis for a specific mortgage loan.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a block diagram of a system for providing pricing and underwriting guidelines for a mortgage loan according to the present invention.

FIG. 2 is a screen shot of an exemplary home Web page for providing pricing and underwriting guidelines for a mortgage loan according to the present invention.

FIG. 3A and FIG. 3B are screen shots illustrating an exemplary user interface implementing a web application for providing pricing and underwriting guidelines for a mortgage loan according to the present invention.

FIG. 4 is a screen shot of a prospective mortgage loan generated by the web application for providing pricing and underwriting guidelines for a mortgage loan according to the present invention.

FIG. 5A and FIG. 5B are a flowchart of the pricing means for providing pricing and underwriting guidelines for a mortgage loan according to the present invention.

FIG. 6 is a flowchart of the updating means for providing pricing and underwriting guidelines for a mortgage loan according to the present invention.

FIG. 7A and FIG. 7B are a flowchart of the conditions means for providing pricing and underwriting guidelines for a mortgage loan according to the present invention.

Similar reference characters denote corresponding features consistently throughout the attached drawings.

### DETAILED DESCRIPTION OF THE PREFERRED EMBODIMENT

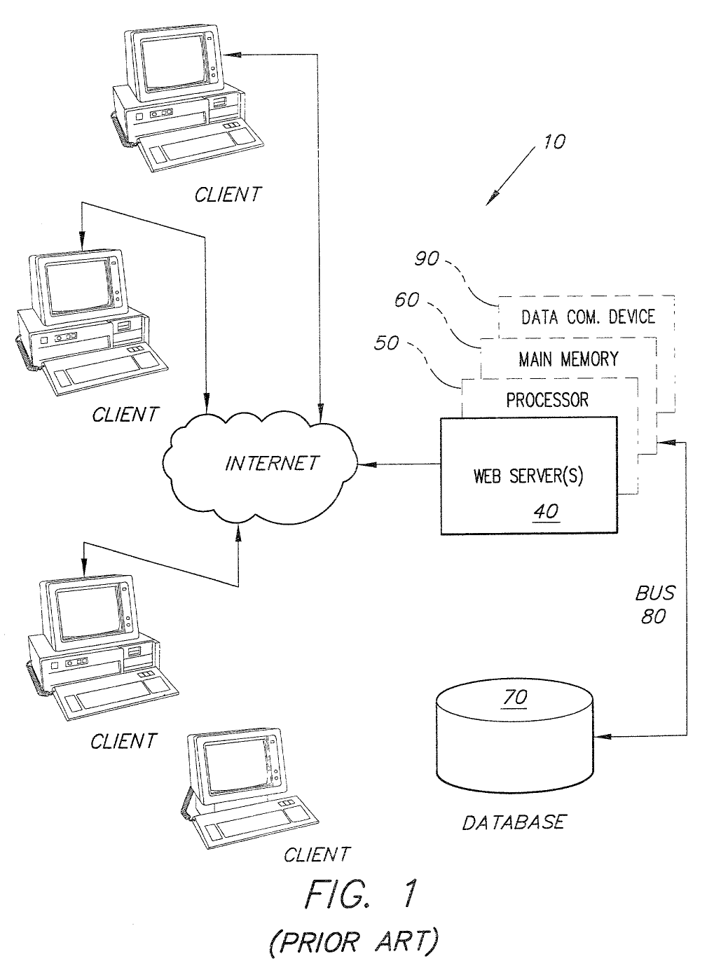

FIG. 1 shows a representative computerized system 10 in which the present invention operates. The computerized system 10 uses a client-server model, including a plurality of clients 20 connected to a Web server 40 through a computer network, preferably the Internet 30, although the system may operate on an intranet or extranet. The Web server 40 has a processor 50 for processing instructions and an area of main memory 60 for executing program code under the direction of the processor 50 connected by a bus 80. The computerized system 10 also includes at least one relational database 70 for storing data. The relational database 70 may reside in an area of disk storage on the Web server 40 and be connected to main memory by the bus 80, or may reside on a remote database server accessible by the Web server 40, as is known in the art. A data communications device 90 is connected to the bus 80 for connecting the Web server 40 to the Internet 30. The client computers 20 have a Web browser operable thereon for receiving and viewing documents written in the Hypertext Markup Language (HTML) and transmitted over the Internet 30 via Hypertext Transfer Protocol (HTTP) by the Web server 40, and transmitting requests for HTML documents to the Web server via HTTP.

The present invention includes software program code stored on a computer readable medium and operable in main memory on the Web server for providing pricing and underwriting guidelines for a mortgage loan, which is accessible to a client computer 20 through the medium of the Internet 30. As used in the present application, the term “computer readable medium” refers to a hard disk drive, a floppy diskette, a ZIP disk, any other magnetic storage media capable of storing coded program instructions, an optical or laser storage device, such as a compact disk or laser disk, paper tape, punch cards, or any other media for the storage of program instructions readable by a disk storage device or reader. The computer program code may be written in Java™ (Java is a trademark of Sun Microsystems), HTML, and XML, or Microsoft's Active Server Pages, and includes code for computing and displaying pricing for all entries of the mortgage loans, as well as program code for updating previous mortgage loans, and program code for generating current underwriting conditions for the mortgage loans.

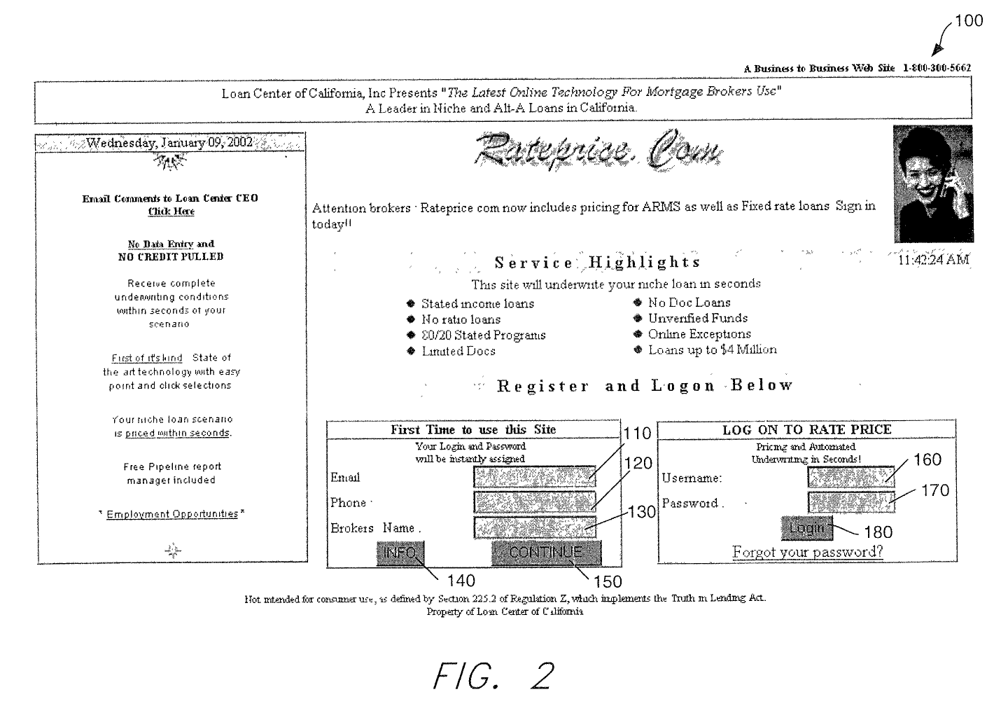

FIG. 2 is an exemplary home Web page 100 which may be published on the Internet by the Web server 40. The home page 100 introduces some of the capabilities of the Web site, which is designed and is specified for the mortgage industry. Without the need of any data entry, a mortgage broker will be able to receive current interest rates and pricing for a variety of mortgage loan scenarios and programs available. Brokers will also be able to obtain immediate underwriting conditions with their respective pricing. Specific underwriting guidelines will be shown within 10seconds from the time the loan parameters are selected and submitted, all with the simplicity of pull-down menus and no time-consuming data entry.

First time registration is self-explanatory, as shown in FIG. 2. A first time user simply enters their respective e-mail address 110, telephone number 120 and broker's name 130 on the Web site. Additional information can be entered by clicking onto the “info” button 140 and registration is continued by clicking onto the “continue” button 150. Logging onto the Web site is continued as a user can enter their respective arbitrary user name 160 and password 170 while clicking onto the “login” button 180 to continue.

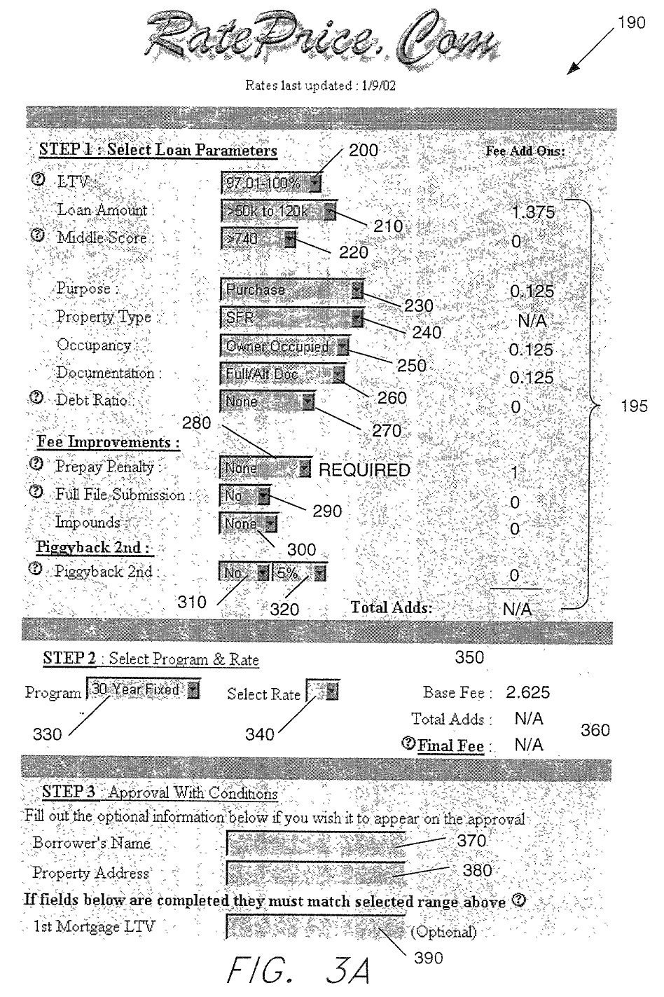

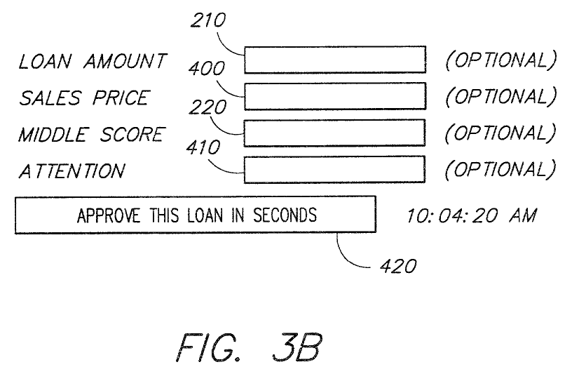

Once logged in, the application is launched on the Web server 40. The user is presented with the loan parameters Web page 190, as shown in FIG. 3A. As previously mentioned, the Web page 190 utilizes dropdown list boxes which are activated by the client computer 20 through mouse clicking the drop-down arrows in the list boxes, or which may be activated by an equivalent series of key strokes (Tab, Arrow, and Enter keys). The loan parameters selected will price both a first and second mortgage loan. The first loan parameter entered is the LTV or loan to value 200. The variety of LTV ranges 200 are contained directly in the drop-down list and are also chosen by the client's cursor. The next loan parameter entered is the loan amount 210, as is also shown on the Web page 190.

Certain fee add-on costs are tied into various loan parameter entries and are shown in the numerical column 195 on the Web page 190. The Web page 190 includes Java Script functions, so that when a parameter is selected from the drop down list box, the fee add-on is automatically changed to reflect the fee add-on 195 based upon the item selected from the list box, based upon the fee add-on rates in effect when the Web page was last updated. The FICO score 220 range, which is a well-known personal credit indicator (to those schooled in the related art), is typically taken from a borrower's credit report, and is also entered using its drop-down list. Other factual entries include the mortgage loan purpose 230, the property type 240, the occupancy 250 and the documentation 260, all of which can be selected using each's respective dropdown list.

Note that the purpose 230, the occupancy 250 and the, documentation 260 can have different corresponding fee add-ons and are essential to providing a mortgage broker with quick and accurate pricing information and underwriting conditions for a specific prospective mortgage loan. The debt ratio 270 is not always a requirement, but can also be selected using its dropdown menu.

The remaining loan parameters include the presence of a prepayment penalty 280, the indication of a full file submission 290, the presence of any impounds 300 and the presence of a piggyback second loan 310. The percentage 320 involved with the piggyback second loan 310 should also be given. These loan parameters are also tied into a respective number of fee add-ons found in the fee add-on column 195. Note that the fee add-ons are automatically displayed and calculated by the application program code and can be used to show different fee add-ons for different respective loan parameters.

Unique to this program is the instantaneous pricing (fee add-ons) of the loan as the parameters are selected. This gives the user the ability to decide whether or not the selected loan scenario and its pricing would be acceptable. The user will also have the ability to select a higher or lower rate, which would increase or decrease the final cost of the selected loan. Once the user decides on the rate and fee and the loan is approvable, the user would be able to lock the loan from the system 10.

Underneath the loan parameters, the desired loan program 330 and interest rate 340 are then finally selected and complete the required information, with the program code displaying the add-on base fee 350 and final fee 360. Although this summarizes the required information, a user can also include optional information if they wish it to appear on the mortgage loan commitment approval.

This optional information is entered directly in text boxes by the user, and must match the previous required information above. This information will help the user maintain a pipeline report and any future information to lock a loan. This includes the borrower's name 370, property address 380, first mortgage LTV 390, and as shown in FIG. 3B, a restatement of the loan amount 210, the sales price 400, the middle FICO score 220, and attention to additional information 410. Once this information is entered, as shown in FIG. 3A and FIG. 3B, the user can click onto the “Approve this loan in seconds” button 420 to generate pricing information and underwriting conditions for a specific prospective mortgage loan.

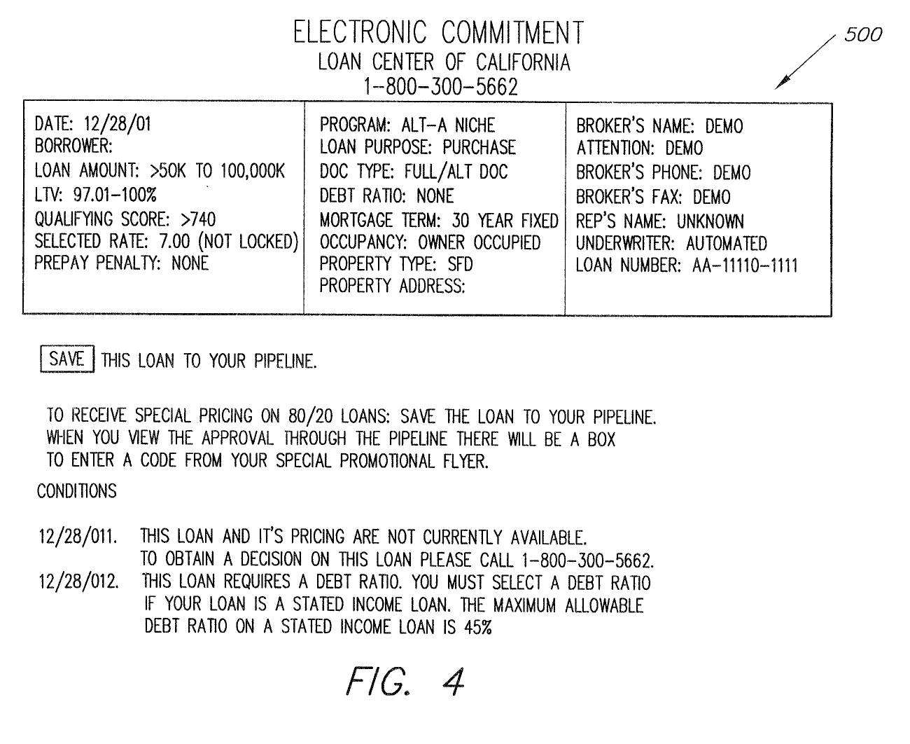

The program code then produces a Web page 500 displaying a copy of some pricing information and underwriting conditions for a specific mortgage loan, as shown in FIG. 4. The specific loan parameters, including a loan number assigned by the program code, are summarized on the top portion of the mortgage loan and are supplemented with a summary of the underwriting conditions. If the mortgage loan 500 is not approvable, an explanation of why it was not approved is provided. The underwriting conditions generated from the mortgage loan selection 500 are specific to the loan parameters given and will give the mortgage broker the exact conditions required to have the loan formally approved.

In the event that the mortgage broker selects a loan parameter that does not fit the lender's guidelines, program code will decline the loan and prompt the broker to use other alternative selections, so that the broker can make an approvable loan. Before the broker submits the mortgage loan 500 to a lender, he will know in advance the specifics of those underwriting conditions and whether he will be able to satisfy those underwriting conditions before he sends the mortgage loan for formal underwriting. Special additional information such as rate sheets, an organizational pipeline, broker information and forms for expedited processing are also available to users and are well-known to those schooled in the related art. The specific mortgage loan 500 may also be saved to the database 70 by clicking the “save” button.

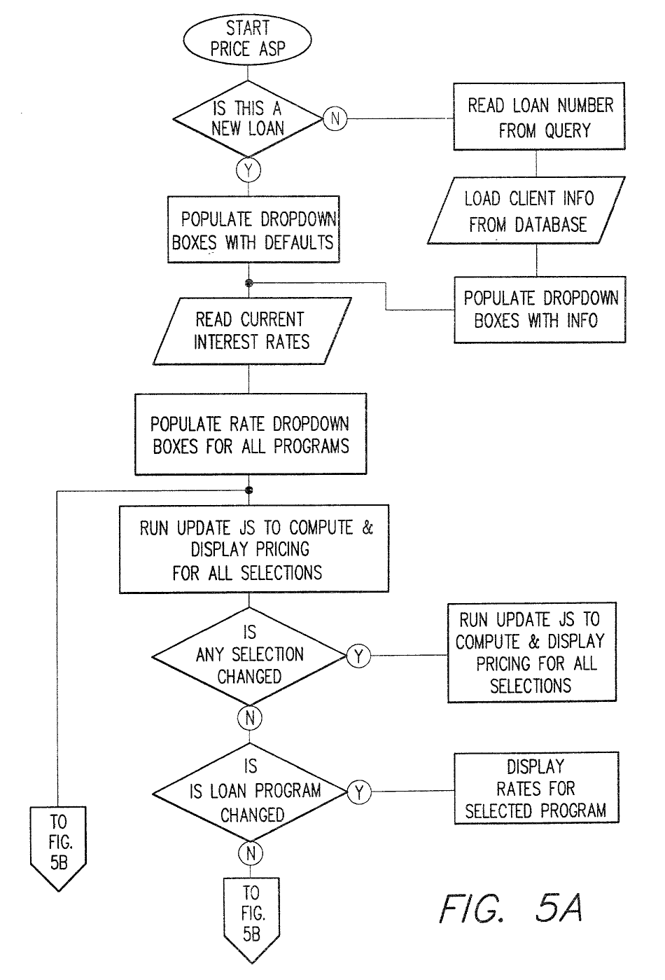

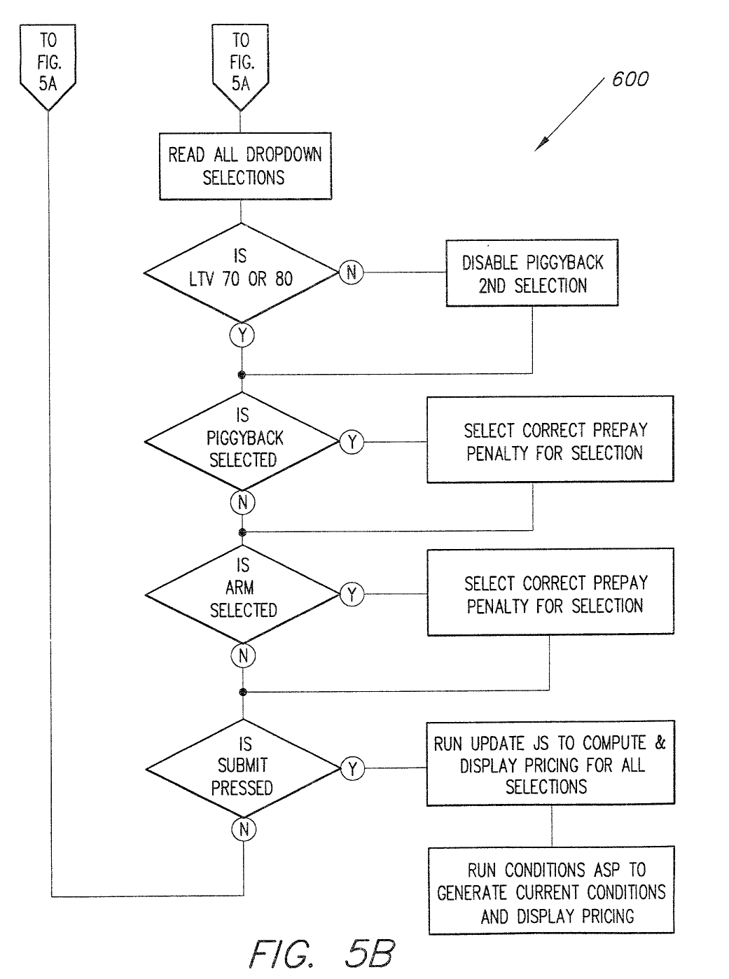

A flowchart of the steps performed by the computer program code for computing and displaying pricing for all entries 600 is shown in FIG. 5A and FIG. 5B. First, the computerized system 10 pricing means determines if the mortgage loan is a new mortgage loan. If the mortgage loan is not new, the loan number is obtained by query to the database 70 and the previous mortgage loan information is loaded from the relational database 70 and is populated to all drop-down boxes.

If the mortgage loan is new, the drop-down boxes shown in FIGS. 3A and 3B are first populated with defaults. The program code then reads the current interest rate that is updated on a daily basis and populates rate dropdown boxes for all programs. The update Java Servlet is run to compute and display pricing information based upon the entries from the dropdown boxes. The program code then determines if any pricing selections have changed. If any selections have changed, the changed selections are again updated. If the loan program 330 is changed, the program will display the new interest rate for the changed loan program 330.

The pricing routine 600 reads all drop-down selections for the new and updated selections. The pricing routine 600 then determines if LTV is at a particular percentage, which in this case is maybe 70 or 80 percent. If the percentage is not at 70 or 80 percent, the second piggyback selection 310 and percentage 320 is disabled. If a second piggyback mortgage is selected 310, the pricing routine will select the correct prepayment penalty 280 for the selected second piggyback mortgage 310. If an adjustable rate mortgage (ARM) is selected, the pricing routine 600 will again select the correct prepayment penalty 280 for the ARM. Finally, if the “approve this loan in seconds” button 420 is selected for submission, an HTTP “POST” method is executed requesting the Web server 40 to execute the update routine 700 to generate the most updated pricing selections, and to execute the conditions routine 800 to complete and generate a Web page 500 with the underwriting conditions for that particular pricing.

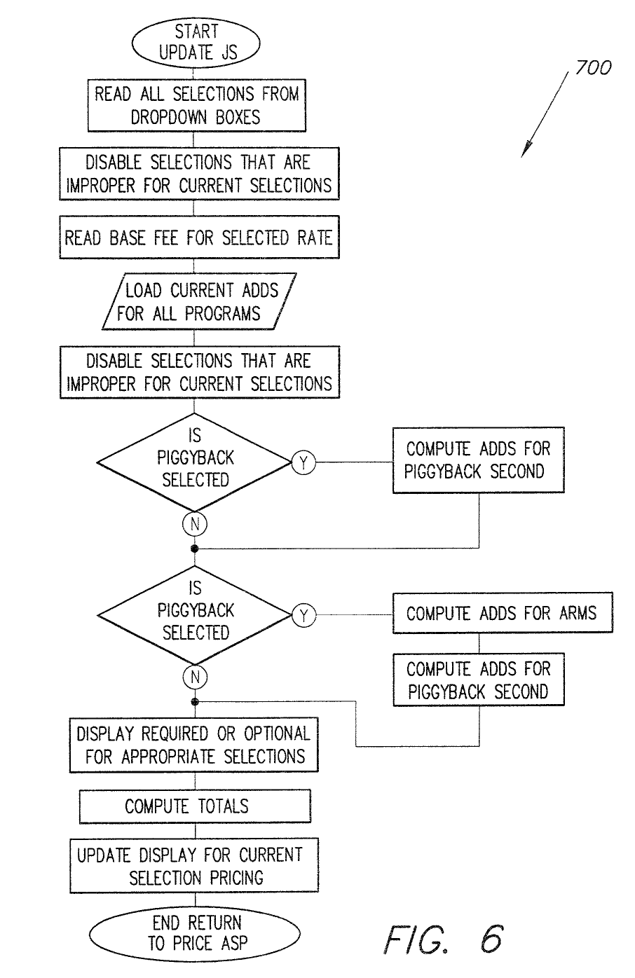

The program code has an update routine 700 performed by a Java servlet or Java Script routine. The update routine 700 is required because fee add-on rates are computed together with the pricing. As shown in FIG. 6, the update routine begins by reading all selections from the drop-down boxes. The update routine 700 then disables selections that are improper for current selections and reads a base fee for a selected rate. The updating routine 700 then loads current adds for all programs and computes adds for current program selections. These adds are the commission that a broker can expect for a particular mortgage transaction and are calculated automatically for a mortgage loan's parameters.

The update routine 700 continues by checking to see if a piggyback mortgage was selected, and if so, computes adds for the piggyback option. Otherwise the update routine 700 checks to see if an adjustable rate mortgage (ARM) was selected and computes adds for the ARM option and selected the correct dropdown boxes for ARMs. The update routine 700 then displays required or optional drop-down boxes for other appropriate user selections. The update routine 700 then computes totals and updates the display for current selection pricing. The update routine 700 then ends and returns to the price routine's Active Server Page (ASP).

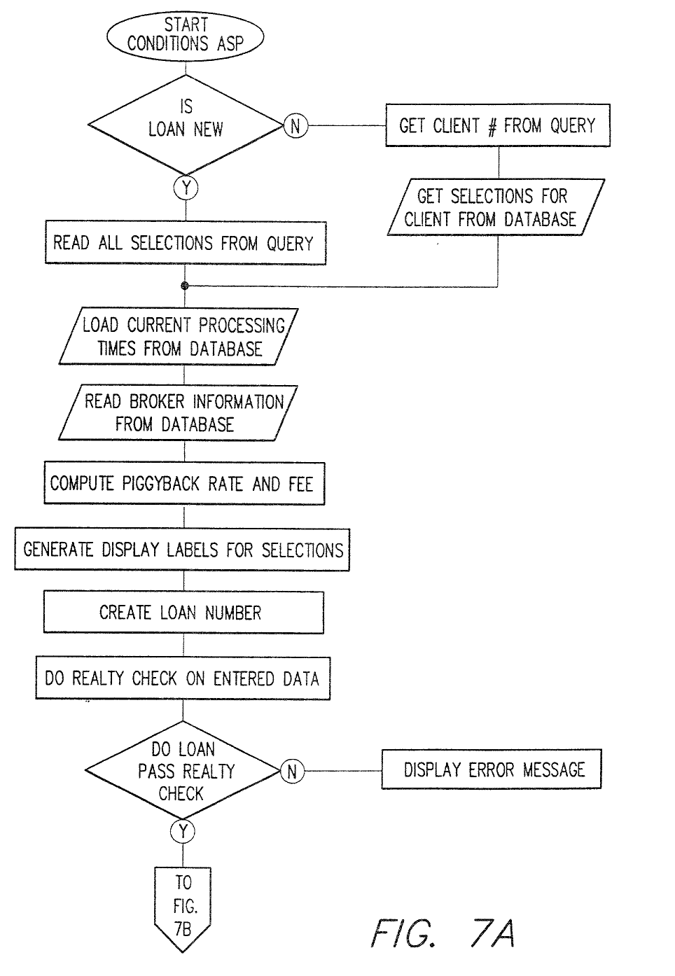

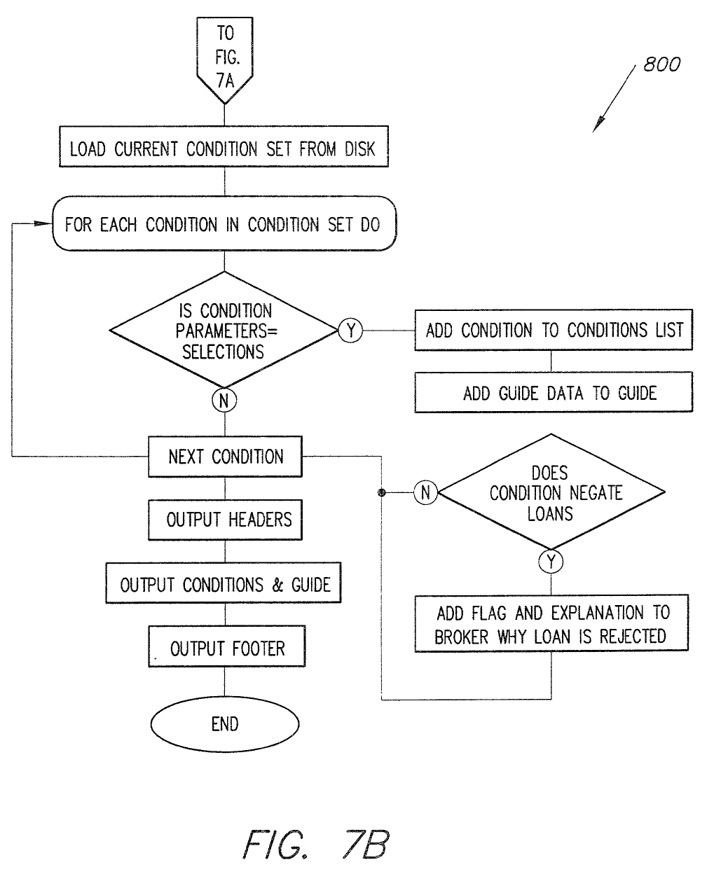

After the update routine 700 is completed, the pricing routine the invokes the conditions routine to determine the underwriting conditions. As shown in FIGS. 7A and 7B, the conditions routine 800 first determines if the mortgage loan is new. If the mortgage loan is not new, the client number or loan number is obtained from the query and the data previously saved for that client or loan are retrieved from the relational database 70. If the mortgage loan is new, the conditions routine reads all selections from the current query. Current processing times and broker information is obtained from the relational database 70. The conditions routine 800 then computes the piggyback rate 320 and add-on fee.

The conditions routine 800 generates display labels for each selection and creates a loan number for each mortgage loan, if none has been previously assigned. The conditions routine 800 performs a realty check on all entered data and determines if the mortgage loan passes a realty check. An error message is displayed if the realty check is not satisfactory.

The conditions routine 800 loads a current condition set from disk storage and compares the condition parameters with the selections made. If a condition parameter is mandated by the selections entered in the pricing routine, then the condition is added to the list of underwriting conditions to be included in the loan agreement and the data for that condition entered with the selection is added to the template. If the condition would negate or result in rejection of the loan, a flag and an explanation to the broker is added to the loan agreement template. The conditions routine 800 then outputs headers, conditions, guides and footers as an HTML page 500 output to the client computer 20.

The Web-pages 190 and 500 displaying add-on fee price information and underwriting conditions may then be printed by the client computer for subsequent review by the mortgage broker.

It is to be understood that the present invention is not limited to the embodiment described above, but encompasses any and all embodiments within the scope of the following claims.

I claim:

1. A computer program product that includes a medium readable by a processor, the medium having stored thereon a set of instructions for a Web-based mortgage broker application, comprising:
(a) a first sequence of instructions which, when executed by the processor, causes said processor to publish a loan query Web page over a network, the Web page having a plurality of drop-down list boxes from which a user may display and select parameters for a mortgage loan, a script routine for calculating mortgage loan add-on fees based upon parameters selected from the drop down list boxes, and having a submit button for submitting the parameters selected to a Web server;
(b) a second sequence of instructions which, when executed by the processor, causes said processor to retrieve updated mortgage loan add-on fees for selected mortgage loan parameters, re-compute add-on fees when add-on fees have changed, and to send a Web page displaying the re-computed add-on fees to a client computer; and
(c) a third sequence of instructions which, when executed by the processor, causes said processor to determine mortgage loan underwriting conditions based upon the parameters selected and to send a Web page displaying the mortgage loan underwriting conditions to the client computer.

2. The computer program product according to claim 1, wherein said plurality of drop-down list boxes includes a list box for selecting a loan-to-value percentage.

3. The computer program product according to claim 1, wherein said plurality of drop-down list boxes includes a list box for selecting a loan amount.

4. The computer program product according to claim 1, wherein said plurality of drop-down list boxes includes a list box for selecting a mortgage loan repayment program.

5. The computer program product according to claim 1, wherein said plurality of drop-down list boxes includes a list box for selecting a mortgage loan interest rate.

6. The computer program product according to claim 1, wherein said first sequence of instructions further includes instruction for displaying text boxes for optionally entering information for identifying a borrower and a property to be mortgaged.

7. A Web-based mortgage broker application system for computing mortgage loan fees and determining mortgage loan underwriting conditions, comprising:
(a) a computer having a processor, an area of main memory for executing program code under the direction of the processor, and a disk storage device for storing data and program code;
(b) a data communications device connected to a network using hypertext transfer protocol, said computer being configured as a Web server;
(c) a software program code stored in said disk storage device and executing in main memory under the direction of said microprocessor, the software program including:
(i) pricing means for publishing a loan query Web page over a network, the Web page having a plurality of drop-down list boxes from which a user may display and select parameters for a mortgage loan, a script routine for calculating mortgage loan add-on fees based upon parameters selected from the drop down list boxes, and a submit button for submitting the parameters selected to a Web server;
(ii) update means for retrieving updated mortgage loan add-on fees for selected mortgage loan parameters, re-computing add-on fees when add-on fees have changed, and sending a Web page displaying the re-computed add-on fees to a client computer; and
(iii) condition means for determining mortgage loan underwriting conditions based upon the parameters selected, and for sending a Web page displaying the mortgage loan underwriting conditions to the client computer.

8. The Web-based mortgage broker application system according to claim 7, wherein said plurality of drop-down list boxes includes a list box for selecting a loan-to-value percentage.

9. The Web-based mortgage broker application system according to claim 7, wherein said plurality of drop-down list boxes includes a list box for selecting a loan amount.

10. The Web-based mortgage broker application system according to claim 7, wherein said plurality of drop-down list boxes includes a list box for selecting a mortgage loan repayment program.

11. The Web-based mortgage broker application system according to claim 7, wherein said plurality of drop-down list boxes includes a list box for selecting a mortgage loan interest rate.

12. The Web-based mortgage broker application system according to claim 7, wherein said pricing means further includes means for displaying text boxes for optionally entering information for identifying a borrower and a property to be mortgaged.

13. A Web-based mortgage broker application method for computing mortgage loan fees and determining mortgage loan underwriting conditions, comprising the steps of:
(a) providing a Web server publishing a loan query Web page over a network, the Web page having a plurality of drop-down list boxes from which a user may display and select parameters for a mortgage loan, a script routine for calculating mortgage loan add-on fees based upon parameters selected from the drop-down list boxes, and having a submit button for submitting the parameters selected to a Web server;
(b) retrieving updated mortgage loan add-on fees for selected mortgage loan parameters;
(c) re-computing add-on fees when add-on fees have, changed;
(d) sending a Web page displaying the re-computed add-on fees to a client computer;
(e) determining mortgage loan underwriting conditions based upon the parameters selected; and
(f) sending a Web page displaying the mortgage loan underwriting conditions to the client computer.

14. The Web-based mortgage broker application method according to claim 13, wherein said plurality of drop-down list boxes includes a list box for selecting a loan-to-value percentage.

15. The Web-based mortgage broker application method according to claim 13, wherein said plurality of drop-down list boxes includes a list box for selecting a loan amount.

16. The Web-based mortgage broker application method according to claim 13, wherein said plurality of drop-down list boxes includes a list box for selecting a mortgage loan repayment program.

17. The Web-based mortgage broker application method according to claim 13, wherein said plurality of drop-down list boxes includes a list box for selecting a mortgage loan interest rate.

18. The Web-based mortgage broker application method according to claim 13, wherein said pricing means further includes means for displaying text boxes for optionally entering information for identifying a borrower and a property to be mortgaged.
